(19) United States
(12) Patent Application Publication
(10) Pub. No.: US 2019/0193622 A1
(43) Pub. Date: Jun. 27, 2019

(54) REFRIGERATED ELECTRIC TRUCK

(71) Applicants: William G Moon, Provo, UT (US); John J Hammerman, Bozeman, MT (US)

(72) Inventors: William G Moon, Provo, UT (US); John J Hammerman, Bozeman, MT (US)

(21) Appl. No.: 15/855,894

(22) Filed: Dec. 27, 2017

(51) Int. Cl. B60P 3/20; B60H 1/00; B60H 1/32; F25D 17/06; F25D 3/10; F25D 29/00

(52) U.S. Cl. CPC B60P 3/20; B60H 1/00378; B60H 1/00428; F25D 29/001; B60H 1/3227; F25D 17/06; F25D 3/105; B60H 1/3232

(57) ABSTRACT

A transportation system includes a truck chassis with a battery supplying power to electric motors for rotating wheels coupled to the chassis; a cooled chamber having a heat exchanger expelling an exhaust gas therefrom; a power generator coupled to the heat exchanger to use the exhaust gas to generate electricity; and a power module carried by truck chassis and for during normal operation, and selectively powering said active refrigeration device with at least one of said battery and said motor.

The present invention relates to a cooled electric truck.

### BACKGROUND

Electric cars have proven to be more than a passing fad. The electrification of cars has spread to trucks. For example, Tesla's four-motor truck was announced with a 500-mile range and some self-driving capabilities. FIG. 1A shows an exemplary electric truck, while FIG. 1B shows a cab of the truck of FIG. 1A.

Electric trucks are disruptive offerings—most long-haul diesel trucks are priced around $120,000 and cost tens of thousands of dollars to operate each year. The all-electric truck will provide more than $200,000 in fuel savings alone over the lifespan of the truck.

### SUMMARY

In one aspect, a transportation system includes a truck chassis with a battery supplying power to electric motors for rotating wheels coupled to the chassis; a cooled chamber having a heat exchanger expelling an exhaust gas therefrom; a power generator coupled to the heat exchanger to use the exhaust gas to generate electricity; and a power module carried by truck chassis and for during normal operation, selectively powering said active refrigeration device with at least one of said battery and said motor, during an idling operation, disabling said motor and powering said active refrigeration device with said battery, and when a grid power connection is available, charging said battery with the grid power while cooling the cooled chamber.

In another aspect, a transportation system includes an electric truck including a chassis with a battery supplying power to electric motors for rotating wheels coupled to the chassis; a cooled chamber mounted on the chassis and having a heat exchanger expelling an exhaust gas therefrom; a mobile self-powered cooling module coupled to the cooled chamber with the heat exchanger; and a power generator coupled to the heat exchanger to generate electricity from the heat exchanger's exhaust gas.

In a further aspect, a method for cooling a system includes transporting goods on an electric truck powered by an energy storage device; providing a cooled chamber powered by the energy storage device, the chamber having a heat exchanger; and generating power from the heat exchanger's exhaust.

In implementations, the cooling module can be a refrigeration system or a cryogenic ultra low temperature system.

### BRIEF DESCRIPTION OF THE DRAWINGS

FIG. 1A shows an exemplary electric truck, while FIG. 1B shows a cab of the truck of FIG. 1A.

FIG. 2A shows an exemplary block diagram of a refrigerated electric truck.

FIG. 2B shows an exemplary block diagram of a refrigerated electric truck.

FIGS. 2C-2D show an exemplary truck or reefer with the cryogenic electrical generator.

FIG. 2F shows an exemplary electric truck motor and battery and control system.

FIGS. 3A-3B shows two operating phases of an exemplary Stirling engine electric generator.

FIG. 4 shows an exemplary cryogenic Sterling engine battery recharger.

FIG. 5 shows an exemplary block diagram of a cryogenics distribution system.

### DESCRIPTION

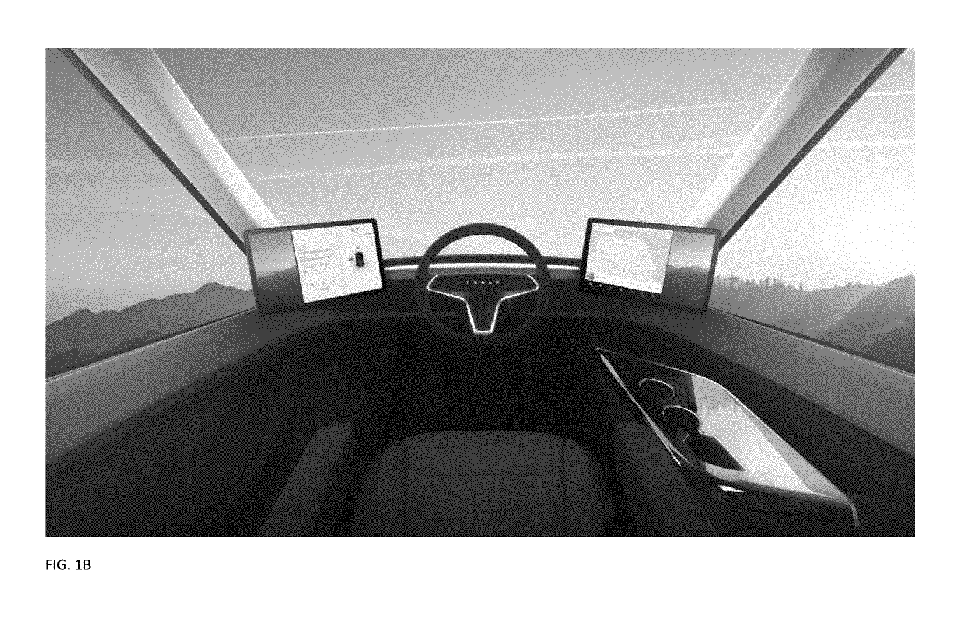

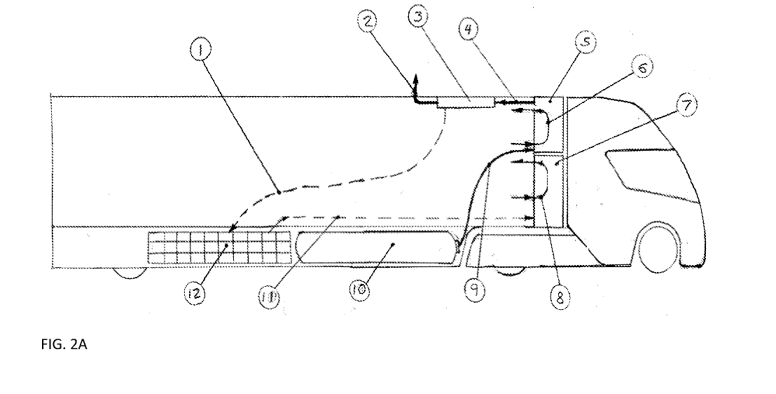

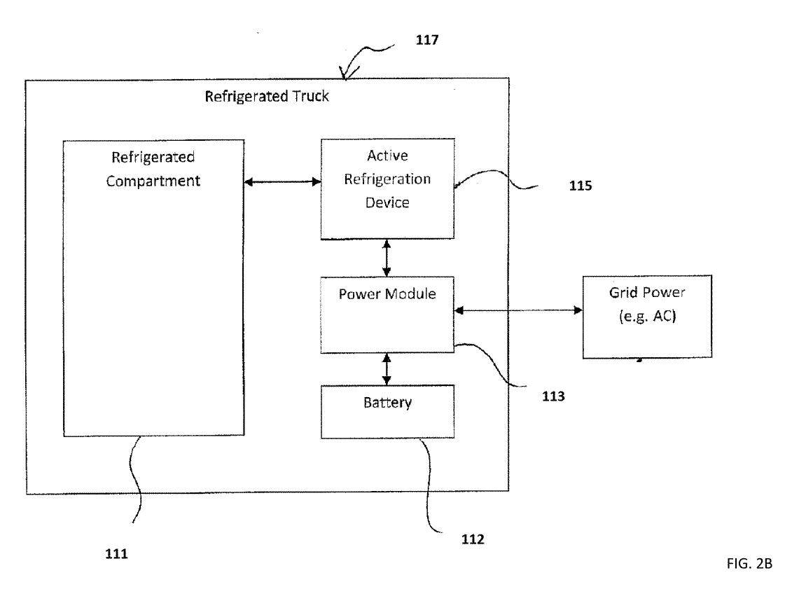

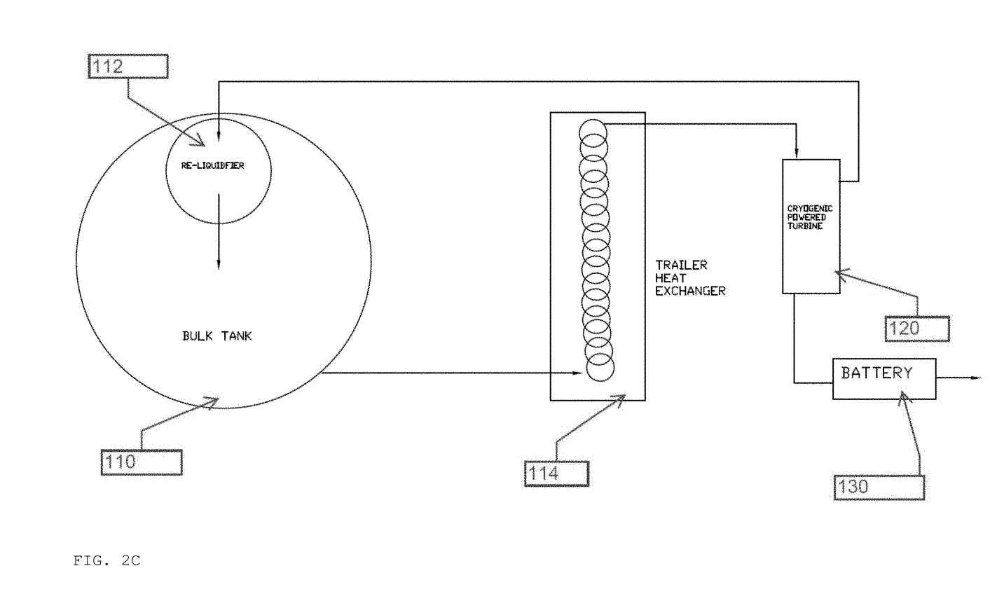

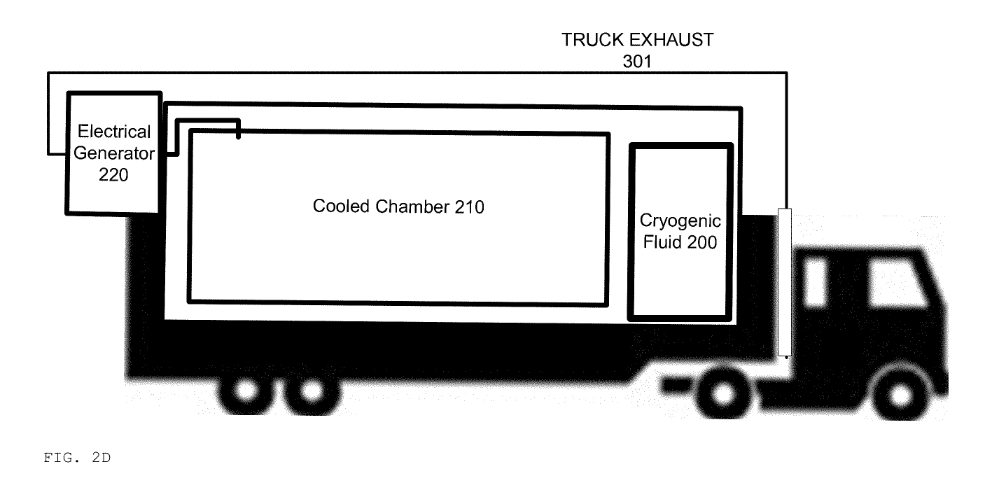

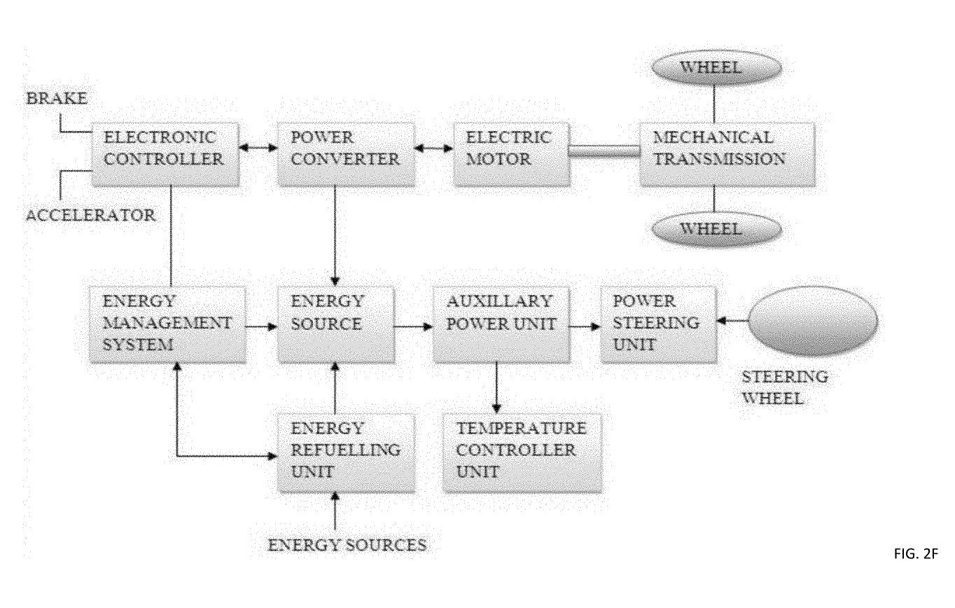

FIGS. 2A-2F shows an exemplary block diagram of an exemplary hybrid semi-tractor trailer that operates on battery and cryogenic power. It is gasoline free and diesel free and has no toxic emissions. The only emission is nitrogen gas, making it a completely green system. The tractor is powered by a set of Lithium Ion batteries located under the cab. The trailer batteries are located below the trailer. The batteries for the tractor are recharged at electric charging stations, similar to the stations used on electric vehicles. The batteries for the trailer are recharged from the cryogenic coolant.

In FIG. 2A, the system includes the following components:
1 Power from cryogenically driven electric generator to batteries
2 Exhaust N2 gas
3 Gas turbine or Sterling engine with electric generator rotating on the same shaft as the engine
4 Exhaust N2 from the cryogenic cooler
5 Cryogenic cooler composed of heat exchanger and fans
6 Air circulation to cool semi-tractor trailer with cryogenic cooler
7 Electric reefer composed of Copeland Scroll Compressor, condenser and evaporator
8 Air circulation to cool semi-tractor trailer with electric reefer
9 LN2 to Cryogenic cooler
10 Cryogenic coolant LN2 tank
11 Battery power to electric reefer
12 Array of batteries

The hybrid semi-tractor trailer that operates on battery and cryogenic power. It is gasoline free and diesel free and has no toxic emissions. The only emission is nitrogen gas, making it a completely green system. The tractor is powered by a set of Lithium Ion batteries located under the cab. The trailer batteries are located below the trailer. The batteries for the tractor are recharged at electric charging stations, similar to the stations used on electric vehicles. The batteries for the trailer can also be recharged at electric charging stations or recharged from a cryogenic coolant power recovery system or directly by a cryogenic medium.

Liquid nitrogen, stored in tanks located below the trailer, flows into the cryogenic cooler and the evaporator inside the cooler. The heat exchanger is quickly cooled to temperatures as low as −196 deg C. as the liquid nitrogen evaporates. Fans pull air from the trailer, cool it through the heat exchanger, and discharge it back into the trailer at a lower temperature.

The nitrogen exhaust gas expands almost 700 times the volume of the liquid nitrogen and creates a high pressure. The high-pressure gas powers a gas turbine which is in direct drive communication with an electric generator. The power output of the electric generator charges the trailer's energy storage device. In the preferred embodiment, this is an array of Lithium Ion batteries. The batteries power an electric reefer that provides cooling in addition to the cryogenic cooler.

In another aspect, the gas turbine is replaced with a Stirling engine. The nitrogen exhaust gas temperature is −20 deg C. or colder. The cold nitrogen gas powers the Stirling engine that is directly coupled to an electric generator. The electric generator charges the trailer batteries that power the electric reefer.

Therefore, the liquid nitrogen cools the trailer during phase change in the heat exchanger and the exhaust gas from the phase change process then flows through a turbine or Stirling engine that produces electricity and further cools the trailer by powering an electric reefer.

In a further aspect, the cryogenic cooler would be eliminated and the liquid nitrogen would flow directly into the gas turbine generator, producing electricity to charge the batteries and operate the electric reefer.

FIG. 2B shows in more details the cooling system. The refrigerated truck system illustratively includes a refrigerated truck 117 comprising a refrigerated compartment 111, and an active refrigeration element 115 coupled thereto for cooling the compartment. The active refrigeration element 115 may comprise a typical coolant based system, i.e. comprising a compressor, a condenser, and an evaporator, each moving coolant in the system. The refrigerated truck 117 illustratively includes a power module 113, and a battery 112 coupled thereto.

The battery 112 receives power from the energy source 1 of FIG. 2A and may comprise a plurality of batteries coupled in series, such as rechargeable batteries. In some embodiments, the battery 12 may comprise a customized lithium ion battery or can even be lead acid battery.

The refrigerated truck system illustratively includes grid power (e.g. power receptacle). When the refrigerated truck 117 is being loaded and unloaded adjacent a structure (e.g. loading dock), the power module 113 may be coupled to the grid power 114. For example, the grid power 114 may provide 120V (3 phase) or 208V AC (3 phase). The power module 113 may provide three phase (30), 208V AC for powering the active refrigeration device 115.

The refrigerated truck 117 may comprise a retractable cable for coupling the power module 113 to the grid power. While coupled to the grid power, the power module 113 detects the coupling to the grid power, and powers the active refrigeration device 115 and charges the battery 1 using the grid power. Once disconnected, the power module 113 switches to the battery 112 as the power source for the active refrigeration device 115. Accordingly, as the refrigerated truck 117 is operated and mobile, the refrigerated temperature of the refrigerated compartment 111 is maintained.

In some embodiments, the refrigeration system of the refrigerated truck 117 may be isolated from the typical electrical systems (main drive train, alternator, and battery) of the refrigerated truck. In other embodiments, the power module 113 may selectively charge the battery 112 using the alternator. In other embodiments, the refrigerated truck 117 may comprise a supplemental electrical generator (e.g. fuel based generator) to selectively charge the battery 112. The passenger compartment of the refrigerated truck 117 may include a toggle switch to selectively enable this supplemental charging feature. In other words, the user of the refrigerated truck 117 may enable supplemental charging of the battery 112 only when necessary, or when operating the truck outside the jurisdiction of typical municipal idling regulations.

In yet other embodiments, the refrigerated truck 117 may use regenerative braking in conjunction with an electrical generator to charge the battery 112 during typical operation. In some embodiments, the above described refrigeration system may serve as a supplement to typical refrigeration power systems, such as a small gasoline power generator. In these embodiments, the passenger compartment of refrigerated truck 117 may include a toggle switch for powering the active refrigeration device 15 using the battery 112 or the typical power element.

Advantageously, the refrigerated truck 117 may cool the refrigerated compartment 111 using only the battery 112, which is charged from the grid power. The refrigerated truck 117 may then satisfy municipal idling regulations.

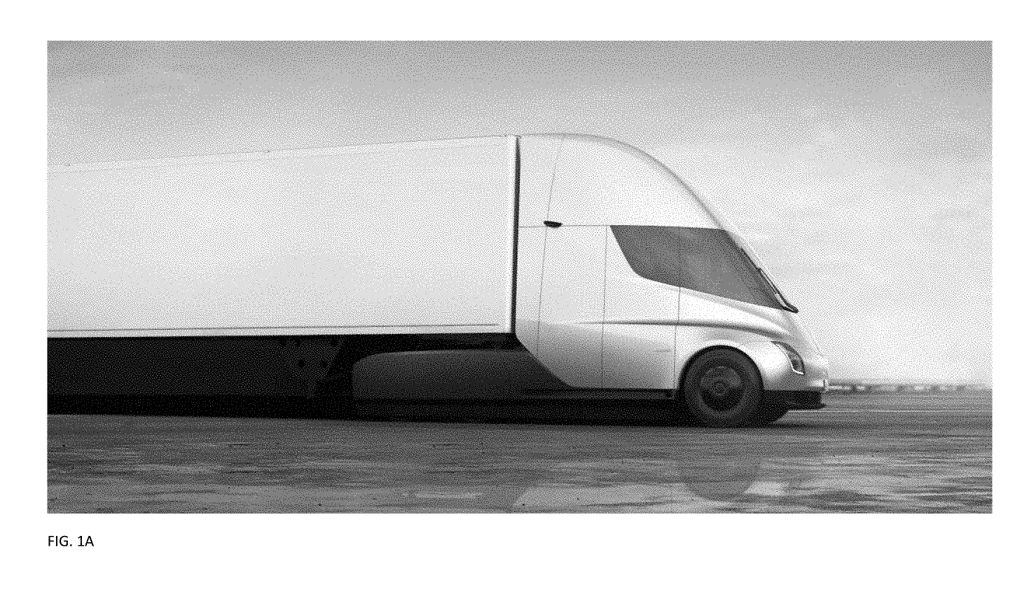

FIG. 2C shows an exemplary cryogenic electrical power generation system. Preferably, the system of FIG. 2C operates with a reefer trailer to supply the reefer's electrical requirements with a non-polluting cryogenic power source. The cryogenic processes consume a cryogenic element as a function of that work. Typically, these processes also require an electrical power source to drive operational items such as valves, controls and other components. The cryogenic processes are then dependent on having a minimum of two energy sources to operate. The system of FIG. 1 captures energy from cryogenic operation and converts the energy to electrical energy.

In FIG. 2C, a bulk tank 110 includes a re-liquefier 112. The bulk tank 110 provides cryogenic fluid to a trailer heat exchanger 114. The exhaust of the heat exchanger 114 of the reefer trailer contains energy in the form of enthalpy, and the natural thermal properties of the effluent are used as a generator fuel. Instead of using just raw liquid as fuel, the exhaust gas, along with the potential of using raw liquid, is used to turn a cryogenic powered engine 120 that charges one or more batteries 130. In one embodiment, the cryogenic powered engine 120 is a turbine type generator, which in turn charges batteries 130 that then supply current to electrical requirements of the reefer trailer. In another embodiment, a Stirling type generator is used to produce the required electrical power source.

FIG. 2D shows an exemplary mobile cryogenic electrical generator mounted on a truck space 202. The heat from the motor is captured as truck exhaust, and such heat is captured and converted into energy. The system of FIG. 2D includes a cryogenic fluid source 200 that is pumped to cool a chamber 210. The exhaust gas from the cryogenic chamber, along with the potential of using raw liquid, is used to turn a cryogenic powered electrical generator 220. The power generator 220 can also recharge a battery/recharger which in turn supplies power and acts as an uninterruptible power source (UPS).

The electric truck consists of three main components—Battery, controller and a plurality of electric motors. The motors used in electric cars can be AC or DC. Mostly DC motors are preferred than AC motors because they are simple to configure and are not at all expensive. For AC motors 3-phase motors have to be used, running at 240V AC. DC motors, on the other hand requires lower voltage, and can also be overdriven for a short period of time. The components are designed in such a way that the motors are imparted maximum torque-speed characteristics. Turning to FIG. 2F, the electric truck has: (1) Energy Source; (2) Power Converter; and (3) Traction Motor. The energy sources consist of Rechargeable batteries, ultra-capacitors and fuel cell. The electronic controller controls the flow of power from energy source to traction motors. The power converter adjusts the voltage according to the load demand. Li-Ion battery is better preferred as energy source because of long life and high energy density but expensive.

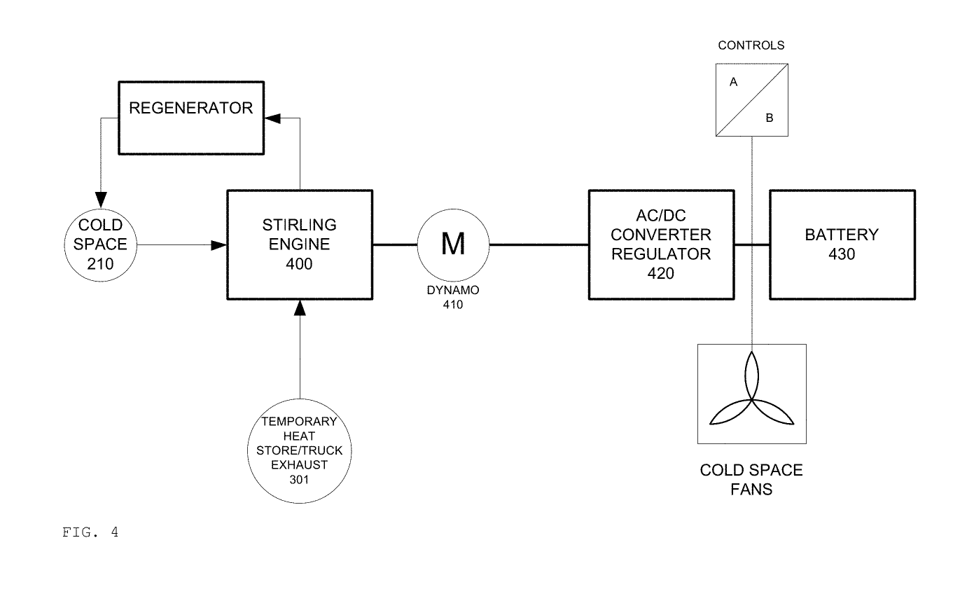

In one embodiment, cryogenic processing requires a relative small amount of electrical power to operate the process control and operational components. In this embodiment, a Stirling engine based electrical power source is used to recharge a battery bank, as detailed in FIG. 4. Conventional electronics convert the direct current voltage supply of the battery bank into the required operational voltages of the cryogenic process. Battery bank capacity is process dependent. By using the Stirling engine as a recharge device, the load on the engine remains constant minimizing fuel consumption. Bulk liquid cryogen is used to “fuel” the Stirling engine.

In another embodiment, the Stirling engine based power source is used to supply the demands of the cryogenic process directly. Conventional electronics condition the output voltage supply into the required operational voltages of the cryogenic process. By using the Stirling engine as a direct supply of electrical power, a minimum of components is required, thus leading to uptime improvement for the cryogenic process while allowing the process to operate in a self-sustaining fashion.

These cryogenic processes can be for continuous operation in environments where the availability of electrical power is limited, inconsistent or non-existent. Diverse processes such as cold chain management, biopharmaceutical manufacturing, processing and storage facilities, blood plasma processing facilities and metal processing facilities are examples of applications which could benefit from the reduction of external electrical power requirements and associated impacts on costs and the environment. The creation of electrical power by using the available cryogens from the process bulk supply to generate the required electrical service allows the process to continue regardless of external factors or conditions, dependent only on the availability of the inherent cryogen

The Stirling engine converts heat energy into mechanical power by alternately compressing and expanding a fixed quantity of gas (the working fluid) at different temperatures. In recent years, the advantages of Stirling engines have become increasingly significant, given the global political environment and as the engineering requirements for environmental responsibility are realized. Stirling engines address these issues by being very compatible with the renewable energy used in cryogenic processes. The Stirling engine is noted for its high efficiency, quiet operation and the ease with which it can utilize what would otherwise be wasted energy.

In this embodiment, engine initialization is realized by “fueling” the engine from a bulk liquid nitrogen tank which uses the natural fluid dynamics of a cryogen to pressurize the upstream cryogenic element. The heat exchanger of the engine has been sized appropriately to supply the necessary heat transfer rates thus producing the appropriate mechanical action necessary to produce the needed electrical current from the alternator.

With the use of liquid nitrogen as a cryogenic element, the system applies a renewable resource which after its use in the cryogenic process is returned to the “feed stock air” for future recovery and use. With the use of this technique, the cryogenic processes become environmentally responsible by eliminating the external electrical power requirement, which, based on average electrical grid compositions is usually associated with the generation of carbon emissions. By recycling or tapping into the inherent cryogenic process component, the cryogenic process becomes self sustaining.

Self-servicing systems are always desirable, demonstrating an evolutionary step forward in process improvement. With a process only dependent on its inherent constituent components for operation, system reliability is improved.

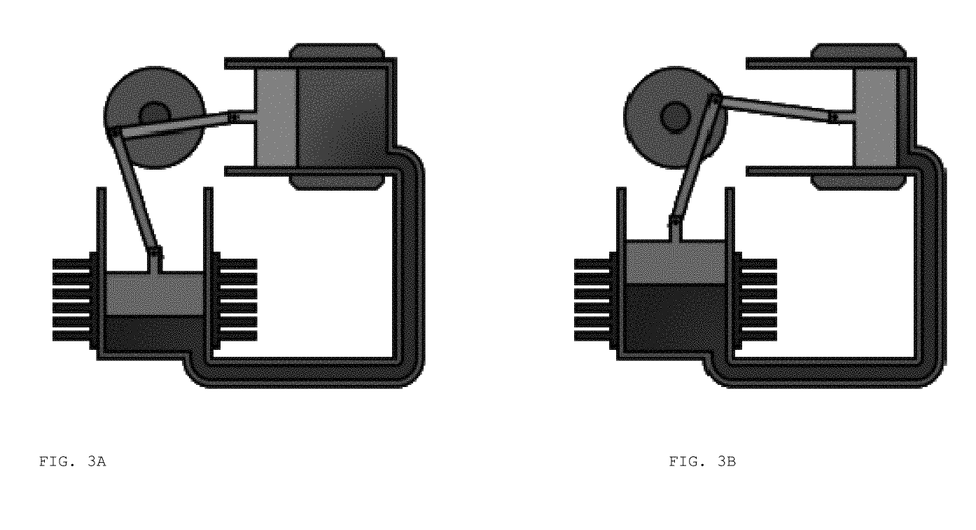

FIG. 3A-3B shows two operating phases of an exemplary Stirling engine electric generator. In one embodiment, an alpha Stirling engine is used which contains two power pistons in separate cylinders, one connected to the hot face portion and one connected to the cold face portion. The hot cylinder is situated inside a high temperature heat exchanger and the cold cylinder is situated inside a low temperature heat exchanger. Most of the working gas is in contact with the hot cylinder walls, it has been heated and expansion has pushed the hot piston to the bottom of its travel in the cylinder. The expansion continues in the cold cylinder, which is 90° behind the hot piston in its cycle, extracting more work from the hot gas. When the gas is at its maximum volume, the hot cylinder piston begins to move most of the gas into the cold cylinder, where it cools and the pressure drops. The cold piston, powered by flywheel momentum (or other piston pairs on the same shaft) compresses the remaining part of the gas. The gas reaches its minimum volume, and it will now expand in the hot cylinder where it will be heated once more, driving the hot piston in its power stroke.

In one embodiment, the Stirling engine has a regenerator which is an internal heat exchanger and temporary heat store placed between the hot and cold spaces such that the working fluid passes through it first in one direction then the other. The regeneration greatly increases the thermal efficiency by ‘recycling’ internally heat which would otherwise pass through the engine irreversibly. As a secondary effect, increased thermal efficiency promises a higher power output from a given set of hot and cold end heat exchangers. The regenerator works like a thermal capacitor and ideally has very high thermal capacity, very low thermal conductivity, almost no volume, and introduces no friction to the working fluid.

In a high power generation embodiment, a greater surface area is needed to facilitate the transfer of sufficient heat. Implementations of the high power embodiments can include internal and external fins or multiple small bore tubes. Preferably, heat may be supplied at ambient and the cold sink maintained at a lower temperature by the cryogenic fluid or ice water.

In another embodiment, instead of the Stirling engine, a modified gasoline engine can be used. In this embodiment, cryogenic fluid is used in lieu of gas. The cryogenic fluid then enters the expansion valve where it drops in pressure and changes state from a liquid to a vapor in the evaporator. Ambient heat causes the cryogenic fluid to expand greatly, pushing the engine's cylinder up. A vent is opened to let the gas escapes, driving the cylinder down, and then the cycle is repeated. The motion of the cylinder generates rotary power that is then applied to a dynamo or suitable electrical power generator.

FIG. 4 shows an exemplary cryogenic Stirling engine battery recharger. The Stirling engine 400 provides rotary power which is applied to a dynamo 410 to generate electricity. The dynamo 410 is essentially an electric motor run in reverse. The electric motor uses magnets spinning in a metal coil to spin an axle. Conversely, spinning the axle causes the magnets to rotate in the coil and generates an electric current moving away from the motor. The dynamo 410 in basic form consists of a powerful field magnet between the poles of which a suitable conductor, usually in the form of a coil (armature), is rotated. The magnetic lines of force are cut by the rotating wire coil, which induces a current to flow through the wire. The mechanical energy of rotation is thus converted into an electric current in the armature. An electromotive force is developed in a conductor when it is moved in a magnetic field.

In one embodiment, the dynamo produces alternating current (AC) which is provided to an AC/DC converter and regulator 620 to generate a regulated DC voltage. The DC voltage is used to recharge a battery 630.

In one embodiment, lithium-ion batteries (sometimes abbreviated Li-ion batteries) are a type of rechargeable battery in which a lithium ion moves between the anode and cathode. The lithium ion moves from the anode to the cathode during discharge and in reverse, from the cathode to the anode, when charging. Lithium ion batteries offer one of the best energy-to-weight ratios, no memory effect, and a slow loss of charge when not in use. The three primary functional components of a lithium ion battery are the anode, cathode, and electrolyte, for which a variety of materials may be used. Commercially, the most popular material for the anode is graphite. The cathode is generally one of three materials: a layered oxide, such as lithium cobalt oxide, one based on a polyanion, such as lithium iron phosphate, or a spinel, such as lithium manganese oxide, although materials such as TiS2 (titanium disulfide) were originally used.[6] Depending on the choice of material for the anode, cathode, and electrolyte the voltage, capacity, life, and safety of a lithium ion battery can change dramatically. Lithium ion batteries are not to be confused with lithium batteries, the key difference being that lithium batteries are primary batteries containing metallic lithium while lithium-ion batteries are secondary batteries containing an intercalation anode material. Other battery chemistries are contemplated as well, including NiMH and NiCd, among others.

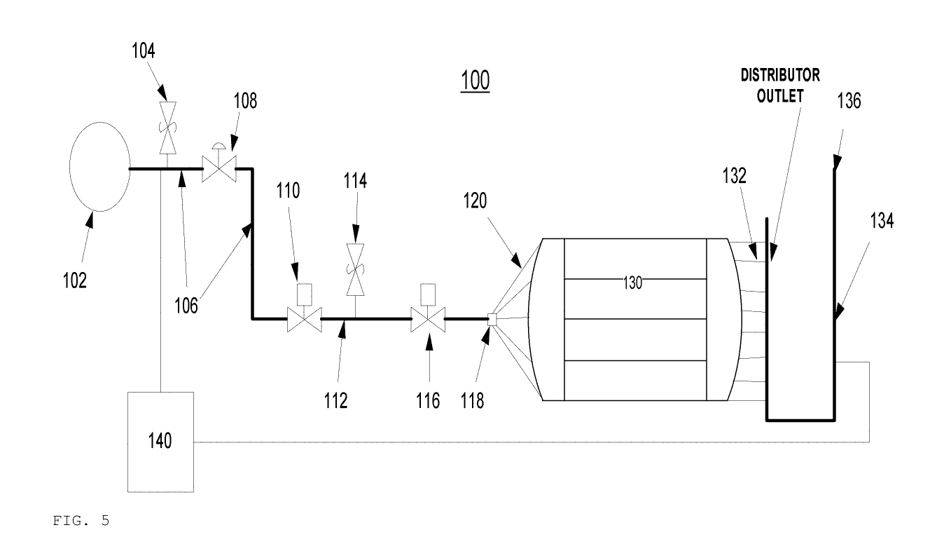

FIG. 5 shows a block diagram of an exemplary cryogenic system 100 in accordance with one aspect of the invention. In this system, cryogenic liquid or material such as liquid nitrogen (LN2) is stored in a cryogenic tank 102. The tank is connected to a relief valve 104 and to a valved supply line 106. The cryogenic main feed to the redundant and control valves to the air evaporator's coil or refrigeration tubing is preferably a high reliability multi-tube thermal exchange structure as disclosed in U.S. Pat. No. 6,804,976, the content of which is incorporated by reference.

The supply line 106 can be a vacuum insulated piping (VIP) line to minimize the vaporization of the cryogens during the transfer of the cryogenic liquids due to heat gain and vaporization. With vacuum insulated piping, the vacuum insulation decreases heat gain caused from conduction, convection, or radiation. In one embodiment, a multi-layer insulation is demonstrably superior to conventional foam insulated copper piping in reducing heat gain to the transferred cryogenic flow.

Fittings for input and output connection to the air heat exchanger air conditioning and or refrigeration source are configured and welded or bayoneted with cryogenic connectors in place. Preferably, the connection between the vacuum insulated pipes is done with a bayonet connector that uses thermal contraction/expansion mechanisms. The contraction/expansion provides a mechanical connection for sections of vacuum insulated pipe with a low heat gain connection. The bayonets are constructed of stainless steel with the nose piece of the male bayonet being made from a dissimilar material such as the polymer INVAR36 to prevent mechanical seizing. A secondary o-ring seal is used at the flange of each bayonet half to provide a seal in which a gas trap is formed between the close tolerance fitting sections of the bayonet assembly. This gas trap is formed using the initial cryogen flow which is vaporized and forms a high pressure inpedence for the lower pressure liquid, thus forming a frost free connection with lowered heat gain to the cryogenic flow.

A manual shut-off valve 108 is connected to the supply line 106 to allow a user to shut-off the system in case of an emergency. The LN2 liquid passes through a redundant valve 110 and enters another valved supply line 112. The supply line 112 has a relief valve 114 and is gated by a control valve 116. In one embodiment, a VIP control valve set up is provided with a redundant safety valve. The safety valve is of the EMO (emergency machine off) type, closed with power removed. The LN2 liquid then travels through a distributor 118 which evenly controls the flow of the cryogenic element over a plurality of lead tubes 120. The lead tubes 120 then complete the enthalpy control to a heat exchanger/evaporator 130 such as the Multi Tube Hi Reliability Tubing discussed in U.S. Pat. No. 6,804,976, the content of which is incorporated by reference.

The lead tubes 120 exit the heat exchanger 130 at a distributed outlet 132. A portion of the Gasses can be vented to the outside through a vent line 134, and the majority is recirculated and reused through a reuse outlet 136. The cryogenic system can be tied to a reliquifier and the cryogenic elements can be reprocessed. Alternatively, the exhaust from the gas exhaust can be used for a different process as Controlled atmosphere to reduce Bio-Deterioration within the payload bay or chamber within the heat source environment.

The temperature range is from ambient e.g +75 degrees Fahrenheit to −120 degrees Fahrenheit. This system controls the flow of a cryogenic element which in turn controls the enthalpic potential of said cryogenic element as it is applied to a heat source which can be Refrigerated Trailers, Environmental Chambers, and computer cooling rooms, among others.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A transportation system, comprising:
a truck chassis with a battery supplying power to electric motors for rotating wheels coupled to the chassis;
a cooled chamber having a heat exchanger expelling an exhaust gas therefrom;
a power generator coupled to the heat exchanger to use the exhaust gas to generate electricity; and
a power module carried by the truck chassis or the cooled chamber or both for use during normal operation, selectively powering said active refrigeration device with at least one of said battery and said motor, during an idling operation, disabling said motor and powering said active refrigeration device with said battery, and when a grid power connection is available, charging said battery with the grid power while cooling the cooled chamber.

2. The system of claim 1, comprising a cryogenic cooling module coupled to the cooled chamber.

3. The system of claim 2, wherein the power generator comprises a turbine or a Stirling engine.

4. The system of claim 1, comprising a direct current converter coupled to the power generator.

5. The system of claim 1, comprising a rechargeable battery coupled to the power generator.

6. The system of claim 1, comprising control electronics receiving power from a battery.

7. A transportation system, comprising:
an electric truck including a chassis with a battery supplying power to electric motors for rotating wheels coupled to the chassis;
a cooled chamber mounted on the chassis and having a heat exchanger expelling an exhaust gas therefrom;
a mobile self-powered cooling module coupled to the cooled chamber with the heat exchanger; and
a power generator coupled to the heat exchanger to generate electricity from the heat exchanger's exhaust gas.

8. The system of claim 7, wherein the power generator comprises a self-generating electrical power source for a cryogenic cooling module.

9. The system of claim 7, wherein the heat exchanger's effluent is used as a generator fuel.

10. The system of claim 7, comprising a turbine and vaporizer that directly connects a cryogenic liquid source to the power generator.

11. The system of claim 7, wherein the cooling module comprises a refrigerator.

12. A method for cooling a system, comprising:
transporting goods on an electric truck powered by an energy storage device;
providing a cooled chamber powered by the energy storage device, the chamber having a heat exchanger; and
generating power from the heat exchanger's exhaust.

13. The method of claim 12, wherein generating power comprises applying a Stirling engine to the cryogenic temperature and ambient temperature.

14. The method of claim 12, where generating power from a cryogen can be used to heat the chamber.

15. The method of claim 12, wherein generating power comprises applying the exhaust to a turbine.

16. The method of claim 12, comprising generating electricity from the heat exchanger's exhaust.

17. The method of claim 12, comprising cooling the chamber using a liquid cryogen, further comprising reclaiming vaporized liquid cryogen.

18. The method of claim 17, comprising directly connecting a cryogenic liquid source to a power generator.

19. The method of claim 12, comprising generating direct current (DC) voltage from the exhaust.

20. The method of claim 12, comprising a charging a battery while operating electronics receiving power from the battery.
